(19) United States
(12) Patent Application Publication
(10) Pub. No.: US 2025/0280046 A1
(43) Pub. Date: Sep. 4, 2025

(54) SERVICE SWITCHING WITHIN A PROXIMITY GROUP WITHIN AN AUDIO PLAYBACK APPLICATION

(71) Applicant: Adeia Guides Inc., San Jose, CA (US)

(72) Inventors: Charles Dasher, Lawrenceville, GA (US); Reda Harb, Tampa, FL (US); Evgeny Kaminsky, Hallandale Beach, FL (US); Jean-Yves Couleaud, Mission Viejo, CA (US)

(21) Appl. No.: 18/592,130

(22) Filed: Feb. 29, 2024

(51) Int. Cl. H04L 65/1089; H04L 9/32; H04L 65/1093

(52) U.S. Cl. CPC H04L 65/1089; H04L 9/3213; H04L 65/1093

(57) ABSTRACT

A playlist may be created in a collaborative manner based on media content recommendations from devices associated with users located in a particular area. A media play device may be set to invite only friends whose device are detected as currently being within a designated area, such as within Wi-Fi range. Invited devices may request that media items, such as songs, be added to the playlist. A content criterion input may impose a content requirement, for example, accepting only songs of a specified genre to the playlist. Media items requested by devices that leave the area may be removed or deprioritized on the playlist. The media play device may also determine from which media content service to obtain each media item on the playlist and may request, from one of the invited devices, a token that provides temporary access to the media content service.

### BACKGROUND

The present disclosure relates to a shared approach to media content generation and, in particular, to device proximity and content criteria requirements for contributing to a curated media content list.

The amount of content available to users in an online content delivery system can be substantial. Consequently, users need technological assistance through an interface that allows users to identify content that they may desire. To find content, users often rely on content service providers to generate recommendations for them based on media consumption patterns, tracked viewing habits of the user, the user's rating of similar content, user demographic information, and the like.

### SUMMARY

A technological problem that arises in curating a playlist of media content is that a user media play device may receive recommendations for media items of many genres and types from a variety of sources, including from social media friends' devices and commercial sources promoting content, which may become overwhelming. For example, a user compiling a playlist of songs on a smartphone or other handheld device may receive song recommendations from a variety of friends, acquaintances, social media network feeds advertising content, and the like, but these song recommendations may be of a genre of little or no interest to the user of the smartphone. Thus, a media playlist may become unwieldly, and media content and media content recommendations may waste storage space on the media play device and may clutter up the user interface with unwanted “junk.” In a related vein, some song recommendations may be of the genre of interest but the recommended song may be of interest for playback at a particular occasion only if the user who recommended the song is currently within earshot of the media play device that will play it. For example, a user may want to compile a playlist of genre X to be shared with a group of friends at a party. A friend who is not present may recommend a song of genre X but since the friend is not present, the party attendees may want to hear only selections requested by people who are present. Similarly, a friend who is present may make a song recommendation, the song may be added to the content playlist, but then the friend may leave the party. In this case, songs requested by a person who is no longer present may clutter up the playlist.

At the same time that too many recommendations may cause a problem, content playlist creation may be stymied by a lack of information about the interests of users present. Content recommendation engines typically function in isolation, working independently to gather pieces of information about a user. This imposes an inherent technological limit on the degree to which the recommendation engine is able to recommend content to an ad hoc group of users who are currently in physical proximity to one another. This may reduce the effectiveness of online content recommending and content providing technology. For example, at an office party it may be desirable to generate a music playlist of upbeat rock music, but the preferences of the attendees of the party may be unknown. It may be helpful to solicit music requests of those present at the party to compile a playlist. However, it may be desirable to have filtering criteria on content requests that are added to the playlist, for example to limit the office party playlist to upbeat rock music without sexually explicit lyrics.

A related technological problem is that content items recommended by friends may be unavailable to the user media play device that received the recommendation. By way of example, a friend's device may be subscribed to a media content service or platform, such as Shmotify, and may submit a song recommendation for a song available via that service but the user media play device that received the recommendation may not be a Shmotify subscriber. Thus, the recommended song may be added to the curated list but the song may be unavailable for play by the user media play device that received the recommendation. This may be disruptive to a continuous playing of songs on the list as a hangup or skip occurs on the user media play device that received the recommendation, which may discourage contributions of content to the playlist.

A technological solution that may be provided according to an aspect of the disclosure is to enable selecting invitee categories or specific invitees who may submit recommendations for a content playlist, and to enable limiting the playlist by genre, subgenre or other category of content. A user may want to set up an ad hoc network comprising devices of users who are nearby and may also limit the content playlist to one or more types of content requests, so that a more personalized content consumption experience may be created. Recommendations for content items that are outside of one or more content criteria, such as content genre, that is set, may be automatically excluded from the content playlist. In this way, a media playlist that is desired by the people present and that is relevant to the genre set may be generated.

Also, when the system detects that a device that recommended a media item is located remotely, for example, outside of a range of wireless radio reception or outside of a Wi-Fi reception area, or when the system detects that the device that recommended a media item, which is already on the list, has left, then the media item may be demoted to a position lower on the list so that the recommending user may consume the content upon his/her return to the area or to the group in an online group environment. Or, in such a case, the recommended media item may be removed from the content playlist. These and other features described herein may save device memory, save “real estate” on the device user display, conserve energy, extend battery life of the device and/or increase wireless communication throughput as the media play device, the devices making recommendations, the media streaming service, and other network resources involved, are not tasked with finding, displaying, requesting, downloading and storing content recommendations, playlists and media content that is not desired by users who are present or that fails to meet the set genre or other content criteria.

Another technological problem arises when a recommended piece of content that meets the content criteria is unavailable from the content library available to the media play device that receives the recommendation. According to an aspect of the disclosure, recommenders may pass along to the media play device credentials or other means for accessing the media content service where the recommended content is accessible. In this way, the media play device that received the content recommendation may retrieve the recommended content from the media content service, even if the media play device, or a user profile associated with the media play device, does not subscribe to the media content service where the recommended content is available. Further, some recommending devices may be subscribers to Shmotify music content service while other recommending devices may be subscribed to Shmappol music platform. The media play device may determine that the recommended content item is unavailable from a first media content service, for example, from a play/view on demand (VOD) content library, or is currently unavailable according to the programming schedule or subscriber restrictions of the media content provider, and may then determine whether the content item is available from the second media content provider.

The recommending devices, at the time they submit their recommendations to the media play device, or at the time the media play device attempts to contact the media content service (or at some other time), may transmit a token comprising credentials for accessing the media content service. For example, the media play device may receive cryptographic credentials for accessing the media content item from the recommending device, or from another user device that is participating in the generation of the content playlist so that the media content item may be accessed. Then, the media play device may keep track of what content recommendation is accessible from what media content service. The media play device may attempt to retrieve or stream the media content from the relevant media content service. The content item may be accessed via an application on the content user device that is associated with the content provider and, if necessary, may be downloaded as needed at the time by the media play device so that the content item sought may be downloaded/streamed/played from the server associated with the relevant content provider. The cryptographic credentials may limit access to the media play device and may contain a time limit for accessing the content item or a limit to the number of times the content item is played. The cryptographic credentials may limit access to the specific content item recommended.

The token may comprise a one-time access code that may be generated, for example, by an application associated with the device from which a media item contribution is being generated for the playlist. For example, the application may generate the token if it determines that the media play device is using a different media service, or may generate the token if its subscription is a top tier subscription (e.g., can access audio files with better quality, at any time, or the like). The token may include login credentials for the appropriate media content service may be passed along to the media play device together with the request for the media item, or the token may be requested by the media play device from the user device that submitted the recommendation. According to an aspect of the disclosure, the media play device may poll the devices in the group to determine which device, if any, subscribed to the media content service where the recommended media item is available. Based on the polling, the media play device may receive the token from the device that has access.

Described are a device, system, non-transitory computer readable medium, method, and means for implementing the method for generating and playing a media item playlist, such as a song playlist based on friend's requests. Such a method may include: receiving, at a first device (which may be the media play device), a user input indicating an invitee limitation for participation in generating a media content list; receiving, at the first device, a content criterion input indicating a content requirement for the media content list; transmitting to a second device, based on the invitee limitation, an invitation for generating the media content list, wherein the second device is distinct from the first device; receiving by the first device, from the second device, at least one media item recommendation; retrieving media content description information for the at least one media item recommendation; determining automatically, based on the media content description information, that the at least one media item satisfies the content requirement indicated by the content criterion input for the media content list; requesting the at least one media item indicated from a media content service; and adding the media item received from the media content service to the media content list.

The invitation for generating the media content list may be transmitted by the first device within a range of radio communication or via Wi-Fi. The invitee limitation may cause the exclusion of devices outside of the range of radio communication area or outside of a Wi-Fi range-such devices would not be sent an invitation.

The first device may receive a token from the devices that make media item recommendations, or from other invited devices. Such a token may include a credential for accessing the media content service, wherein the first device requests the media item from the media content service using the credential.

If the second device is not detected as being present within a range of radio communication area or within a Wi-Fi range, a media item that it had recommended may be removed from the media content list. In response to detecting that the second device is not present within a range of radio communication or within a Wi-Fi range, the media item that it had recommended may be deprioritized on the media content list.

The content requirement indicated by the content criterion input may be a requirement for a content genre for the media content list. For example, the media play device may filter media item recommendations received and add to the playlist only those that are within the genre limitation. Also, the first device may receive from the second device, a content criterion modification request, for example, a user of the second device may wish to change the genre from blues to all jazz. In response, the first device may set a modified content criterion by modifying the content requirement indicated by the content criterion input according to the content criterion modification request. The media content list may be updated according to the modified content criterion.

Media items on the list may be played to identify the user or device that requested each media item, or at least to provide clues to it. For example, the first device may play the media item using a sound effect indicating a direction or distance of the second device from the first device.

The system may determine from which media content providing server, platform or service to request the media item. The first device may access the media item at a first media content service. In response to determining, by the first device, that a second media item is available from a second media content service, it may request the second media item from the second media content service. In an embodiment, the first device may identify a second device that has access to a content item at a first media content service, in its local storage or in another device to which the second device has access, and then request the second device to stream the content item to the first device, so that the first device may relay it to the playback system. Or, the first device may instruct the second device to stream said content item directly to the playback system.

### BRIEF DESCRIPTION OF THE DRAWINGS

The above-described and other features of the present invention, its nature and various advantages will be more apparent upon consideration of the following detailed description, taken in conjunction with the accompanying drawings, and in which:

FIG. 1 illustrates an example of a media play device communicating with user devices that may contribute media item recommendations to be added to a playlist and with media content providers that may transmit media items of the playlist, according to an aspect of an embodiment of the disclosure;

FIGS. 2-4 illustrate user interfaces for creating and viewing the playlist generated, according to an aspect of another embodiment of the disclosure;

FIG. 5 illustrates an example of a system, including the media play device and a user device providing a recommendation for media items, according to an aspect of the disclosure;

FIG. 6 is a block diagram illustration of an example of user equipment in accordance with an aspect of the disclosure;

FIG. 7 is a flowchart showing an example of a process for playlist management, according to an aspect of the disclosure;

FIG. 8 is an example of a communication and process flow diagram for generating a playlist, according to an aspect of the disclosure;

FIG. 9 is an example of a communication and process flow diagram for updating the playlist, according to an aspect of the disclosure;

FIG. 10 is an example of a communication and process flow diagram for managing spatial audio sound effects for the playlist, according to an aspect of the disclosure;

FIG. 11 is an example of a communication and process flow diagram for adding audio effects, according to an aspect of the disclosure;

FIG. 12 is an example of a communication and process flow diagram for adding user personalization, according to an aspect of the disclosure;

FIG. 13 is an example of a communication and process flow diagram for is user confirmation of the playlist, according to an aspect of the disclosure;

FIG. 14 is an example of a communication and process flow diagram for additional user device discovery, according to an aspect of the disclosure;

FIG. 15 is an example of a communication and process flow diagram for auxiliary content buffering, according to an aspect of the disclosure;

FIG. 16 is an example of a communication and process flow diagram for content buffering, according to an aspect of the disclosure; and

FIG. 17 is an example of a communication and process flow diagram for content decay management, according to an aspect of the disclosure.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood that the embodiments and examples described herein may be practiced without these specific details. In other instances, well-known methods, procedures and components, including software, firmware and hardware components, have not been described in detail so as not to obscure the embodiments described herein. Also, the description is not to be considered as limiting the scope of the embodiments described herein.

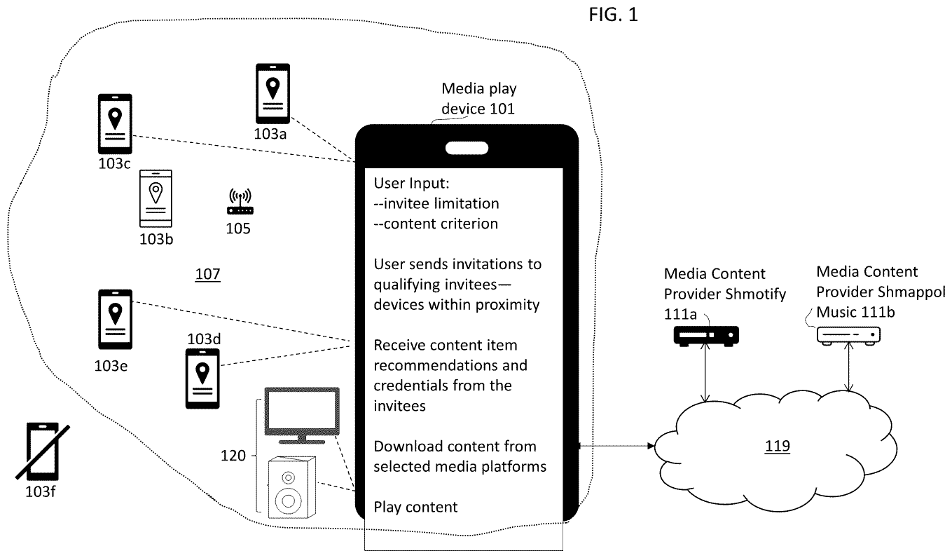

Aspects of an embodiment of the disclosure will now be described with reference to the example shown in FIG. 1. From time to time, a user may wish to generate a content playlist on a media play device 101. For example, it may be desirable to set up a “virtual jukebox” for a particular event or occasion so that participants who are present may make song requests or other content recommendations to be played by the media play device 101.

As referred to herein, the terms “content item,” “media asset,” “media item,” “content” or the like should be understood to mean an electronically consumable user asset, such as a song or other musical piece, television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, audio books, blogs, advertisements, chat sessions, social media, applications, games, and/or any other media or multimedia and/or combination of the same. As referred to herein, the term “multimedia” should be understood to mean content that utilizes at least two different content forms described above, for example, text, audio, images, video, or interactivity content forms. Content may be recorded, played, displayed or otherwise consumed, or accessed by user equipment devices, but can also be part of a live performance, such as a sports game or other event.

FIG. 1 illustrates that media player device 101 is within an area 107 that also includes area devices 103a-103e. Media player device 101 may provide a user interface to enable receiving user input indicating a set of devices that are detected within area 107, which may then be invited to submit recommendations for media content items to be added to the playlist. In an embodiment, the user interface may enable the user to select from among area devices that are detected within the area 107. This may make it easier for a user of media play device 101 to generate a list of invitees. As also shown in FIG. 1, the media play device 101 may be connected to one or more output devices 120, shown by way of example as a monitors/TVs and speakers, for displaying and/or for providing audio output contained in the media item represented by items on the play list that is generated. The media play device 101 may be connected to one or more output devices 120 by wired or wireless connection. Further, the system may automatically create a list of invitee devices based on the fact that they are located within area 107. For example, the area 107 may be defined as the area in which devices that are within a Wi-Fi range or within a radio frequency range, e.g. within a received signal strength indication (RSSI) that indicates that the devices 103a-e are likely sufficiently close to the media play device 101 or to the devices 120 so that users associated with the devices 103a-e can listen and enjoy the media being played thereby. The Wi-Fi router is shown as 105. The media play device 101 and the devices 103a-e and 120 may communicate via a network, for example, by accessing a network server. Geofencing with GPS coordinates may also be used to detect proximity of area devices 103a-103e or to define area 107. The user input may specify manually a specific list of devices that the user wishes to invite to make media recommendations.

In an embodiment, media play device 101 may set a primary group of invitees by selecting a criterion as an invitee limitation, such as “All users near me,” in which case devices 103a-e of users within the area 107 may be invited to share media item requests to the playlist. Other, more specific invitee limitations may include, for example, “Spotify users near me,” “Facebook friends near me,” or “Users who have previously sent media recommendations to me.” The user interface of the media play device 101 may provide options that may be selected for invitee limitations—device criteria or user criteria for invitees, for example, “Users who have sent me a media recommendation for 1990s rock to me.” Other such options that may be selected by the user of the media play device 101 may be “Users who have sent me a media recommendation for 1990s rock if I accepted and played the media recommendation for 1990s rock,” “Users whom I previously invited in this area,” “Users of this area [that is, area 107] who have sent me a media recommendation that I accepted and played,” “Any device associated with a user profile of person X who sent me a media recommendation within the past 90 days,” or other such group identification criteria or combinations thereof. The media play device 101 may transmit the invitations based on the invitee list thus generated.

Also shown is secondary device 103f, which is outside area 107 and does not meet the requirement of being in the area and thus will not be an invitee device. In an embodiment, media play device 101 may automatically invite devices within the area 107 and may also invite device 103f outside area, for example, if the device 103f outside the area 107 requests to be invited. Similarly, device 103b is inside the area 107 but is not identified as a friend's device—it may have a user profile that does not contain user information that meets invitation criteria. Thus, the media play device 101 may not transmit an invitation to device 103b to contribute to the playlist.

In an embodiment, the area 107 may be a virtual area and may comprise one or more devices located remote from the media play device 101. For example, users may wish to invite users remote from a current location of a birthday party to submit recommendations for a playlist. For example, device 103f may first request to be added as an invitee in response to which the media play device 101 may generate a user prompt requesting approval or disapproval of adding device 103f as invitee. In an embodiment, devices 103a-103e may first have to take a step of requesting to be included as invitees of media play device 101 in order to be added as invitees to submit media item recommendations. An ad-hoc network may be established to measure proximity to the media play device 101. A distance threshold, for example, the area in which the output of devices 120 may be consumed, for example, 10-100 meters, or an area approximately corresponding to the location of an event, such as a beach or house party, for example, 25-50 meters, may be set to establish the boundary of the area 107. In an embodiment, localization of the device 101 and 103a-f may also be obtained using other means, such as using GPS.

In an embodiment, if the system detects that a device 103d leaves the area 107, then media items recommended from the device 103d may be automatically removed from the playlist. If the device 103d is again detected to be in the area 107 then media items recommended from the device 103d may be automatically returned to the playlist.

According to a further embodiment, if the system detects that a device 103d leaves the area 107, then media items recommended from the device 103d may remain on the playlist but be deprioritized. Such a media item recommendation may be suspended and not played, but then restored to active status if the device 103d is again detected within the area. In this way, if a user associated with the device 103d temporarily leaves the area, for example, to use the restroom or to chat privately, the user's recommended media items are not played—the user gets to consume the media items that s/he recommended when the user returns. In an embodiment, while the media item is suspended, it may not lose its place in the queue but continues to move up in the queue as media items ahead of it are played. However, while the media item is suspended, if it reaches the top of the queue it is not played but remains next in line to be played until the device 103d is again detected to be within the area 103d, at which the point the media item returns to active status and may be played because it is next on the playlist. Relatedly, a media item may be suspended for a period of time, for example, 1-30 minutes, and then permanently removed from the playlist.

In an embodiment, if the system detects that a device 103d leaves the area 107, then media items recommended from the device 103d may be decayed and moved down on the playlist queue. In this way, users who stay in the area 107 and participate more in an event may consume their media items more frequently, and also users who are temporarily out of the area are less likely to miss the time when their media item selections are played. For example, if the system detects that a device 103d leaves the area 107, then media items recommended from the device 103d may be moved down to the bottom of the queue of the playlist. Or, how far down in the queue the media items are moved down may depend on the frequency or on the length of the device's absence from the area 107. For example, if the device 103d is detected to be away for more than 20 minutes, then media items recommended from the device 103d may be decayed and moved down to the bottom of the queue, and if the device 103d is detected to be away for more than 5 minutes, then media items recommended from the device 103d may be decayed and moved down halfway down the queue.

According to an aspect of the disclosure, the media play device 101 may also accept a user selection of one or more content criteria. A content criterion may limit the type of media content that may be added to the playlist. For example, a content criterion may indicate a genre of music, songs of an artist, band or orchestra, a genre of films, films starring a particular star or made by a particular director, media items available from one or more media content providers (e.g. songs on Apple Music), content that is scheduled to be broadcast at a particular time, for example, in the near future or broadcast currently, a subgenre of content, and/or a genre with user-created criteria, such as rap music with nonviolent and not sexually explicit lyrics, or a combination of such criteria.

In an embodiment, media items that are recommended by devices 103a-e are filtered by the media play device 101 to ensure that they meet content criteria. The media play device 101 may use content metadata to ensure that the media items recommended match content criteria, such as genre, or may search for metadata to determine genre information, producer, performer, recording label, media content provider where the media item is available or scheduled for broadcast, and other such information to determine suitability for the playlist based on the content criteria. The media play device 101 may use content metadata to determine whether a media item recommended for the playlist contains violent or sexually inappropriate content. Also, a trained machine learning model may be used to determine whether the recommended media item meets one or more content criteria. For example, a recommended song may be identified and its lyrics may be retrieved. The machine learning model may determine whether the lyrics of the song contain sexually explicit, violent, or otherwise offensive lyrics unsuitable for an office party or unsuitable for a children's birthday party, or conforms to other aspects of the genre that had been set for the playlist. Or, the machine learning model may determine whether a song comprises upbeat dance music that meets content criteria specified for a dance party.

According to an embodiment, the media play device 101 may automatically determine whether the media item is available before adding it to the playlist. In an embodiment, media items may be added to the playlist only if the media item may be obtained free of additional charge for play by the media play device 101. The media play device 101 may determine one or more sources where the media item is available. For example, the media play device 101 may by default first attempt to find the media item on one or more local storage devices. Failing that, the media play device 101 may next determine whether the media item is available from a media content provider to which the media play device 101 or a user profile associated with the media play device 101 has access, for example, has a subscription. In an embodiment, the user devices 103a-e may also communicate with 111a, b in order to see available content items that they want to recommend, to get tokens as necessary, to subscribe, to access content, to grant permissions to other devices to access content, including for temporary access, to request permission from other devices to access content, including for temporary access, or the like.

According to an embodiment, if the media item is unavailable from those sources, the media play device 101 may automatically determine one or more sources where the media item is available. An ad-hoc network may be established to exchange authorization token(s) or for a device to stream to another master device (one of the devices 103a-e could become the master device, instead of streaming to the media play device 101). Communication between the devices 101 and 103a-f may also take place via a server. For example, the devices 101 and 103a-e may each connect to an online platform to enable playlist generation, management and token sharing. The media play device 101 may automatically determine that the media item is available from media content provider 111a and 111b. Further, the media play device 101 may determine that it and a user profile associated with it, lack free access to these media content providers 111a, 111b. The media play device 101 may query device 103a, the device that transmitted the request, to provide an authorization token for these media content providers 111a, 111b. In an embodiment, the media play device may poll the devices in the group to determine which device, if any, subscribed to the media content service where the recommended media item is available. Based on the polling results, the media play device may receive the authorization token from the device that has access.

In a further embodiment, the devices 101 and 103a-e may elect which device streams the playlist. There could be a voting mechanism to elect the device that generates the least amount of authorization tokens to optimize network traffic (technical effect) or minimize inconvenience if sharing items is capped by the content provider. In a further embodiment, the devices 101 and 103a-e may elect which device plays the playlist.

As shown in FIG. 1, the media play device 101 may play media items of the playlist via a monitor and/or speakers and/or other output devices 120 connected by wired or wireless connection to the media play device 101. There may also be a voting mechanism to elect the device that has integrated or has access to the best sound system, for example, with separate woofer, base and tweeter, the highest resolution rate, to generate the best audio and/or video output. In an embodiment, the media play device 101 may identify a second device 103a-e with access to a content item and the second device 103a-e may stream the content item to the media play device 101 to relay it to the playback system 120 or instruct the second device 103a-3 to stream said content item directly to the playback system 120.

The device 103a may transmit the token for media content provider 111a to the media play device 101. The device 103b may transmit the token for media content provider 111b. The media play device 101 may then access each requested media item on the respective one of these media content providers 111a, 111b. The media play device 101 may thus request authentication and authorization token(s) enabling the media play device to act on behalf of the plurality of respective devices/users to: create a playlist and to enable the playback of the shared media items.

According to an embodiment, the media play device 101 may automatically determine the preferred media content provider of participating area devices 103a-103e or of user profiles associated with them. The media play device 101 may then access the media item from the media content providers 111a, 111b that is most preferred, or that is most subscribed to, by the participating devices. Or, the media play device 101 may poll the invited devices 103a-e to determine whether any of them have access, or have access, to the media content provider that has the media item requested.

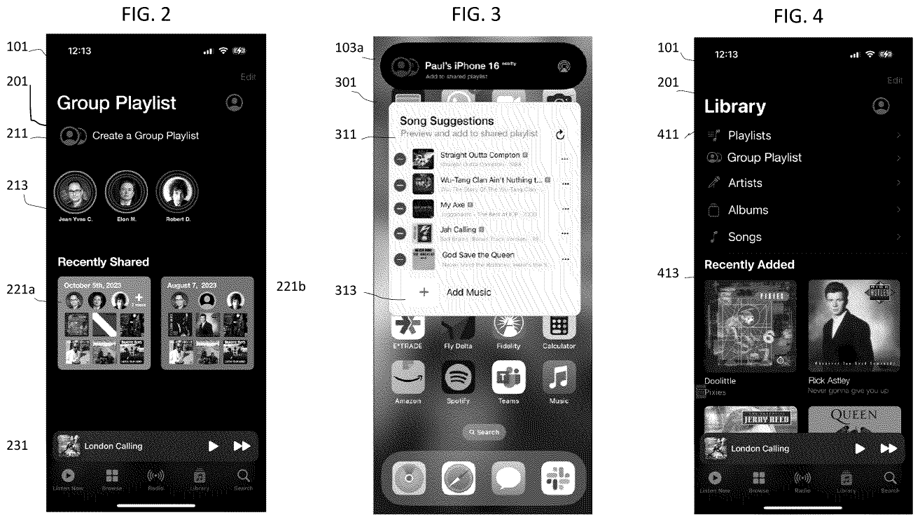

FIG. 2 illustrates a user interface 201 of the media play device 101 which may be used to select invitees 213 or groups of invitees. User interface 201 includes an option for creating a group playlist 211 and for inviting various friends as invitees 213. In an embodiment, the media play device 101 may associate known friends of a first user associated with the media play device 101 with the devices of the friends. For example, the friends may be those within the “friends” network of the first user on a social media network or on a chat group or a text group or a fellow subscriber to one or more of the same media platforms, and the system may automatically determine whether devices within the area 107 proximal to the media play device 101 are associated with user profiles of such friends. Such a determination may be made by the media play device 101 requesting that devices 103a-e which are detected within the area 107 indicate user identifying information from a user profile associated with each device 103a-e. Or, a Wi-Fi system may provide user identifying information about devices detected within the Wi-Fi range. Such devices may be added to the list of invitees upon selection of the friend shown at 213.

In an embodiment, friends, or a subset of friends, of a user profile associated with media play device 101 may automatically be populated as a group to an invitee list. For example, a user of the media play device 101 may have a group of friends designated in a WhatsApp chat group of “Beach friends” with whom the user sometimes goes to the beach. This group of friends may be the ones with associated names and photos shown at 213. In response to selection at the media play device 101 of all devices of this group, these devices may be added to the invitee list. Or the devices of this group that are detected as being within the area 107 may be automatically invited. As shown, user interface 201 of the media play device 101 may also provide a shorthand ways of recreating previous playlist 211: the images 221A, 221B may indicate respective playlist, including the dates, media items on the play list, and the name/photo associated with devices that contributed to the playlist or were invited to contribute to the playlist.

The media play device 101 may specify the shared playlist theme or genre is “Catalina Mixer” or “Mid to Late 1980's Billy Joel”. This theme may be transmitted to each secondary user's preferred media content provider 111. In an embodiment, the media content provider 111 may create a recommendation of a plurality of media items to present to the devices 103a-e so they may select specific media items presented, or so they may propose to modify the indicated theme or genre. In an embodiment, the invitation may specify content criteria for the playlist, and a device 103a-e that accepts the invitation may automatically pass on these content criteria to a media content provider that it uses, for example, Apple Music. In this way, the media content provider would provide only content that matches the content criteria. According to an aspect of such an embodiment, the content criteria thus transmitted to the media content provider of the device 103a-e would be used only for the generation of the playlist but would not be used for future media item recommendations for the device 103a-e—that is, the user associated with the device 103a-e would continue to receive the user's ordinary selections. In this way, according to this aspect of the embodiment, the device 103a-e may continue to receive content recommendations form the media content provider without the media content provider's recommendations being swayed by the content criteria of the playlist generated for this special occasion as dictated by a user other than the user associated with the device 103a-e.

FIG. 3 illustrates a user interface 301 of an invited device 103a. The media play device 101 may communicate with the user device 101 via network technology, Bluetooth Low Energy (BLE) or the like. In addition to other communication, in an embodiment, BLE may be used to determine the direction or distance from the media play device 101—for example, the media play device 101 may evaluate distance to other device, or at least measure variations in distances to devices 103a-e, and decide to drop/re-prioritize content items accordingly, as discussed herein. In an embodiment, a link for the BLE may first be established, such that the devices authenticate their identities over the internet and exchange BT/BLE keys and then established a mesh network. Upon acceptance by the device 103a-e, the device 103a-e may transmit an identification of a media item along with an authentication (and authorization) token for a media content provider service and connection information (such as an API endpoint) to the media play device 101, which may be used to obtain media items from a media content provider 111. A list 311 of media items recommended for the playlist may be shown by user interface 301 along with an option to add more media items to the playlist.

As shown in FIG. 4, the media play device 101 may include the user interface 201 that has various menu options 411 for creating and controlling playlists. A recently added section 413 of the user interface 201 may show recently added media items together with a description thereof.

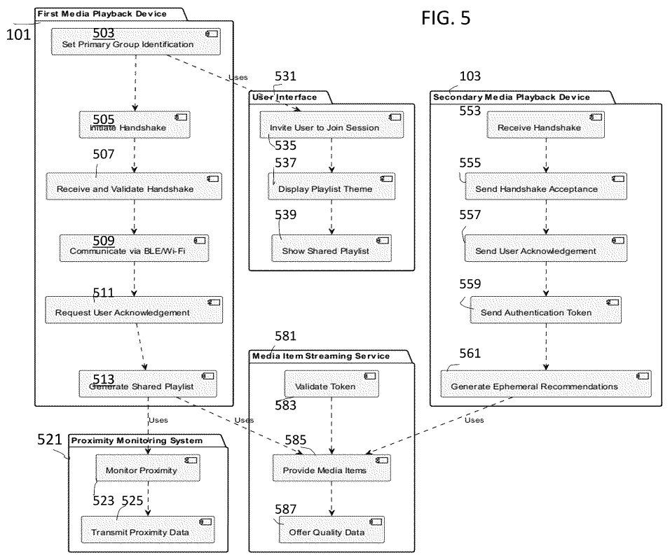

FIG. 5 illustrates various devices and some of their components and functions, including, a media play device 101 (electronic device equipped with a processor and memory) such as a mobile phone, car head unit (infotainment system), smart assistant or portable speaker, a secondary media playback device, a proximity monitoring system 521, and a media item streaming service 581. The presence of components of devices and device components and modules that are not explicitly shown or named may be inferred by the functions and actions herein described. For example, the media play device 101 may receive a user input that enables setting a primary group identification selection criterion. This may be accomplished by communication circuitry of the media play device 101 that provides or is in communication with user interface 531.

A device authenticator 505 of the media play device 101 may initiate an encrypted handshake with secondary media playback device 101. This signal from the media play device 101 may contain digitally signed payload data that includes at least one group membership criterion, such as “devices that are on my company list who are in my area 107.” A digital signature may entail a secret key-public key cryptological approach. The transmitted message may be encrypted by the device signing the message using a secret key, known only to the signing device. Any device that receives the message may then decrypt the message using a public key, obtainable to anyone, that works only for a message encrypted by the secret key of the sending device. In this way, the recipient may be assured that the message was encrypted by the party who claims to have signed it. Thus, the media play device 101 may digitally sign messages transmitted to the devices 103.

Each device 103, upon receipt of the signal initiating a handshake, has the option to send back an acceptance signal, which may be digitally signed and encrypted handshake. This acceptance signal may include a unique identifier that may be generated by a cryptographic co-processor within the respective device. The unique identifier serves for authentication and ensures secure connection establishment. Additionally, the acceptance signal may, based on the one or more membership criteria, indicate the user's or device's membership status in the invitee group. When the media play device 101 at 507 receives and validates the handshake acceptance signals, and verifies the membership status, the media play device 101 may communicate directly, with the device 103 by establishing a secure connection, as shown at 509. As shown at 511, upon connection, the media playback device 101 may request acknowledgement from the device 103 to join the shared playlist session and may provide the opportunity to request that a media item identifier be added to the play list.

The user interface of the invited devices 103a-e may provide a widget for notifying users of the opportunity to request that media items be added to the playlist and may also include an identification of the content criteria, such as the genre, for media content for the playlist. The user interface of the invited device may enable the user of the invited device to add requested media items to the playlist for transmission to the media play device 101. The user interface of the invited device may enable the user of the invited device to download an app that provides such an interface for adding media items to the play list and for seeing what media items other invited devices have been adding. For example, media play device 101 may transmit to each invited device in real time the media item that is added by an invited device, and may also identify a user of the device that added each media item. In an embodiment, requested media items that are downloaded to an invited device may be transmitted to the media play device 101 along with the request to add the media item to the playlist. At 513, the play list is generated based on media item identifiers received from the devices 103. In an embodiment, device 103 generates an ephemeral authorization for the media play device 101 to play the media item only once and then the media item gets deleted. In an embodiment the media item is streamed to the media play device 101, which then plays it on its own output device or via the output devices 120. Or, the media play device 101 may instruct the relevant device 103a-e to play the media item on the playback system 120 directly when that media item comes up in the queue.

User interface 531 may be a module or a set of modules of the first media play device 103. At 535, user devices may be invited to join a session. As discussed, user devices 103a-e may be invited according to user input or based on user profile information associated with the media play device 103. At 537, the user interface 531 of the media play device 103 may display a theme for the playlist, which may be a genre requested by the input to the media play device 101 to limit suggestions that are to be accepted for the playlist. At 539, the playlist that is generated may be displayed on the interface 531.

Also shown in FIG. 5 is functionality that may be provided by modules of the devices 103 is shown. At 553, the secondary media playback device 103 may receive a handshake request from the media play device 101. As discussed, the handshake may entail cryptological means for encrypting and signing the request for the handshake. At 555, the secondary media playback device 103 may authenticate the identity of the media play device 101. At 557, the secondary media playback device may accept the handshake and transmit the acceptance to the media play device 101. At 559, user device 103 may send a token providing credentials or cryptological data for accessing the media content provider from which the selected media item is available to enable the media play device 101 to request one or more content items from media items streaming services 581. According to an aspect of the disclosure, the authentication token may be transmitted directly from secondary immediate playback device 103 to media items streaming service 581. A batch of such media item identifications requested to the secondary immediate playback device 103 may be transmitted simultaneously or through a series of accessing actions. The media play device 101 and/or one or more additional secondary devices 103 may transmit media item requests to the secondary immediate playback device 103. For example, the media play device 101 and/or one or more additional secondary devices may determine that they lack access to one or more media items on the playlist because they lack subscription to the media item streaming service 581. In response to such a determination, the media play device 101 and one or more additional secondary devices may transmit media items identifications to the secondary immediate playback device 103 so that the secondary immediate playback device 103 may transmit media items identifiers to the media item streaming service 581.

The requested media item may be returned either to the second media playback device 103, which may then transmit the media item on the playlist to the first media, playback device 101. Or, the media item streaming service 581 may transmit the requested media item requested by the secondary immediate playback device 103 two the media play device 103.

In an embodiment, the secondary device 103 may transmit to the media play device 101 an indication that the secondary device 103 has or lacks access to the media item it is requesting. The secondary device 103 may do this before, together with, or after the transmission of the request for the media item to the media play device 101. For example, the second media playback device 103 may indicate that the second media playback device 103 has, or has not, a copy of the media item in its memory and/or may indicate that the second media playback device 103 has or has not access to a server, such as a media streaming service or other platform, for accessing the media item.

Block 521 shows proximity monitoring system and its components and services, which are used by the media play device 101 to detect one or more secondary media playback devices within the proximal area 107. Proximity monitoring system 521 may be part of the media play device 101 or may be accessed by the media play device 101. For example, proximate monitoring system 521 may be a Wi-Fi router or other type of sensor that detects proximity of secondary immediate playback devices.

The proximity monitoring system 521 may include a proximity monitor 523 that detects the presence of one or more secondary media playback devices within the area 107 or that may register only devices within the area 107 that have been specified, according to a group of invited devices as specified by the media play device 101. Proximity monitoring system 521 may also include a proximate data transmission 525 that transmits the proximity data indicating the presence of devices to the media play device 101.

After the generation of the play list with the requested media items, a playlist may be transmitted to one or more media item streaming services 581. Or, media items may be individually requested from a media item streaming service 581. For example, the media play device 101 may access information regarding media items from two or more media item streaming services 581, determining to request a download or streaming of each media item that pertains to the appropriate media item streaming service 581.

At 583, the media item streaming service 581 may validate the token, such as subscription information received as part of the request for the media item. At 585, the media item streaming service 581 may provide the media item requested. At 587, the media item streaming service 581 may offer quality data at various data quality levels-varying by data transmission rates and/or by how may bits are used to encode the media item (e.g. standard vs. 4k video files).

In an embodiment, the media play device 101 may have access to the media item selected for the playlist and/or modified playlists and may sort, modify, filter, and aggregate one or more playlists into a combined playlist. The media items within the aggregated playlist may include metadata such as but not limited to source location information, playback authorization tokens, as well as other content metadata.

In an embodiment, the media play device 101 may attempt to “reconcile” media items that are not sourced initially from the memory of the media play device 101 to “match” media items from the combined playlist to media items which are available from the first media playback device's preferred media item streaming service. For example, using the International Standard Recording Code (ISRC), which is a standard used to uniquely identify sound recordings, the media play device 101 may match media items to respective streaming services where they are available.

Access to the content item may be limited by the cryptographic credentials to one or more plays of the content item, and/or for a period of time, such as, for example, for 48 hours, or a week or the like. The cryptographic credentials may also limit access in other ways, for example, to disable downloading of the media item onto user devices other than to the media play device 101 or to limit viewing to one time without repeated play.

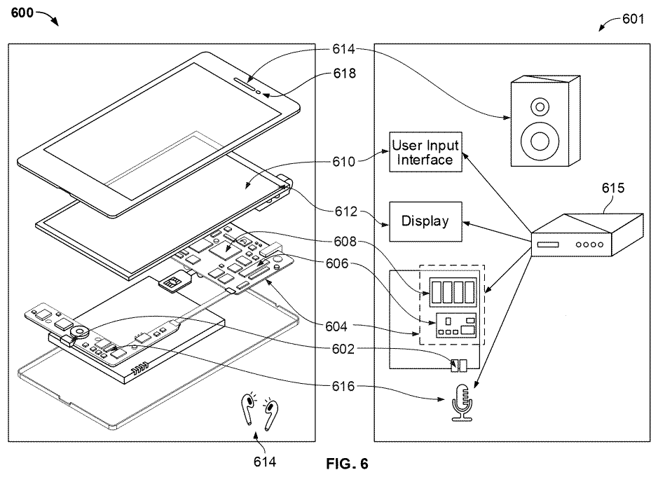

FIG. 6 describes illustrative devices, systems, servers, and related hardware for the systems and methods described herein. FIG. 6 illustrates generalized embodiments of user equipment 600, described by way of example as a handheld device, such as a cellphone, but may be implemented as other user equipment described herein. For example, user equipment 600 may be a tablet, a virtual reality or augmented reality device, or any other suitable device capable of processing video data. User equipment 600 may comprise, or may be communicatively connected to structures shown in FIG. 6, including, microphone 616, audio output equipment (e.g., speaker or headphones 614), and/or display 612. In some embodiments, display 612 may be a television display or a computer display. In some embodiments, the circuit boards may include control circuitry, processing circuitry, and storage (e.g., RAM, ROM, hard disk, removable disk, etc.). In some embodiments, the circuit boards may include an input/output path.

Each user equipment device may receive content and data via input/output (I/O) path 602 that may comprise I/O circuitry (e.g., network card, or wireless transceiver). I/O path 602 of user equipment 600 may provide content (e.g., broadcast programming, on-demand programming, Internet content, content available over a local area network (LAN) or wide area network (WAN), and/or other content) and data to control circuitry 604, which may comprise processing circuitry 606 and storage 608. Control circuitry 604 of user equipment 600 may be used to send and receive commands, requests, and other suitable data using I/O path 602, which may comprise I/O circuitry. I/O path 602 may connect control circuitry 604 (and specifically processing circuitry 606) to one or more communications paths (described below). I/O functions may be provided by one or more of these communications paths, but are shown as a single path in FIG. 6 to avoid overcomplicating the drawing.

Control circuitry 604 may be based on any suitable control circuitry and may include processing circuitry 606 and communication circuitry. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i9 processors) or multiple different processors (e.g., an Intel Core i7 processor and an Intel Core i9 processor). In some embodiments, control circuitry 604 executes instructions for stored in memory (e.g., storage 608). Specifically, control circuitry 604 may be instructed by an application to perform the functions discussed herein. In some implementations, processing or actions performed by control circuitry 604 may be based on instructions received from an application associated with one or more of the content providers 111a and/or 111b.

In client/server-based embodiments, control circuitry 604 may include communications circuitry suitable for communicating with a server or other networks or servers, including with the content providers 111a and/or 111b. The application associated with one or more of the content providers 101 and/or 111 may be a stand-alone application implemented on a device or a server. The application associated with one or more of the content providers 111a and/or 111b may be implemented as software or a set of executable instructions. The instructions for performing any of the embodiments discussed herein of the application associated with one or more of the content providers 111a and/or 111b may be encoded on non-transitory computer-readable media (e.g., a hard drive, random-access memory on a DRAM integrated circuit, read-only memory on a BLU-RAY disk, etc.). For example, in FIG. 6, the instructions may be stored in storage 608, and executed by control circuitry 604 of a device 600.

In some embodiments, the application associated media play device 101 may be a client/server application where only the client application resides on device 600 (e.g., device 101), and a server application resides on an external server. For example, the application associated with the media play device 101 may be implemented partially as a client application on control circuitry 604 of device 600 and partially on server as a server application running on control circuitry 611. Server 111a, 111b may be a part of a local area network with one or more of devices 600 or may be part of a cloud computing environment accessed via the internet. In a cloud computing environment, various types of computing services for performing searches on the internet or informational databases, providing applications associated with one or more of the content providers 111a and/or 111b, generation, providing storage (e.g., for a database) or parsing data (e.g., using machine learning algorithms described above and below) are provided by a collection of network-accessible computing and storage resources, referred to as “the cloud.” Device 600 may be a cloud client that relies on the cloud computing capabilities from server to determine whether processing (e.g., at least a portion of virtual background processing and/or at least a portion of other processing tasks) should be offloaded from the mobile device, and facilitate such offloading.

Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry.

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as application associated with one or more of the content providers 101 and/or 111 data described above. Nonvolatile memory may also be used (e.g., to launch a boot-up routine and other instructions). Cloud-based storage, described in relation to FIG. 6, may be used to supplement storage 608 or instead of storage 608.

Control circuitry 604 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 604 may also include scaler circuitry for upconverting and downconverting content into the preferred output format of user equipment 600. Control circuitry 604 may also include digital-to-analog converter circuitry and analog-to-digital converter circuitry for converting between digital and analog signals. The tuning and encoding circuitry may be used by user equipment device 600 to receive and to display, to play, or to record content. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from user equipment device 600, the tuning and encoding circuitry (including multiple tuners) may be associated with storage 608.

Control circuitry 604 may receive instruction from a user by way of user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of each one of user equipment device 600 and user equipment device 601. For example, display 612 may be a touchscreen or touch-sensitive display. In such circumstances, user input interface 610 may be integrated with or combined with display 612. In some embodiments, user input interface 610 includes a remote-control device having one or more microphones, buttons, keypads, any other components configured to receive user input or combinations thereof. For example, user input interface 610 may include a handheld remote-control device having an alphanumeric keypad and option buttons. In a further example, user input interface 610 may include a handheld remote-control device having a microphone and control circuitry configured to receive and identify voice commands and transmit information to set-top box 715.

Audio output equipment 614 may be integrated with or combined with display 612. Display 612 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 612. Audio output equipment 614 may be provided as integrated with other elements of each one of device 600 and equipment 601 or may be stand-alone units. An audio component of videos and other content displayed on display 612 may be played through speakers (or headphones) of audio output equipment 614. In some embodiments, audio may be distributed to a receiver (not shown), which processes and outputs the audio via speakers of audio output equipment 614. In some embodiments, for example, control circuitry 604 is configured to provide audio cues to a user, or other audio feedback to a user, using speakers of audio output equipment 614. There may be a separate microphone 616 or audio output equipment 614 may include a microphone configured to receive audio input such as voice commands or speech. For example, a user may speak letters or words that are received by the microphone and converted to text by control circuitry 604. In a further example, a user may voice commands that are received by a microphone and recognized by control circuitry 604.

The application associated with the media play device 101 may be implemented using any suitable architecture. For example, it may be a stand-alone application wholly implemented on each one of user equipment device 600 and user equipment device 601. In such an approach, instructions of the application may be stored locally (e.g., in storage 608), and data for use by the application is downloaded on a periodic basis (e.g., from an out-of-band feed, from an Internet resource, or using another suitable approach). Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, one or more of the applications associated with one or more of the media play device 101 and/or secondary devices 103a-f may be downloaded and interpreted or otherwise run by an interpreter or virtual machine (run by control circuitry 604). In some embodiments, the application associated with the media play device 101 may be encoded in the ETV Binary Interchange Format (EBIF), received by control circuitry 604 as part of a suitable feed, and interpreted by a user agent running on control circuitry 604. For example, the application associated with the media play device 101 may be an EBIF application/or may be defined by a series of JAVA-based files that are received and run by a local virtual machine or other suitable middleware executed by control circuitry 604. In some of such embodiments content received the media play device 101 may be, for example, encoded and transmitted in an MP3 format, or as MPEG audio and video packets of a program.

User equipment may be coupled to communication network 119. Communication network 119 may be one or more networks including the Internet, a mobile telephone network, mobile voice or data network (e.g., a 5G, 4G, or LTE network), cable network, public switched telephone network, a local area network (LAN) or Wi-Fi, a mesh network or an ad hoc or other types of communication network or combinations of communication networks. Paths (e.g., depicted as arrows connecting the respective devices to the communication network 7119) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths.

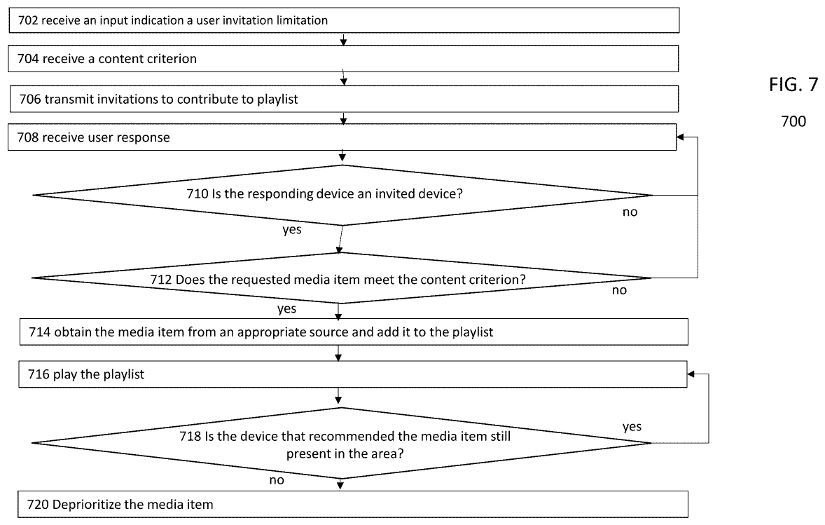

FIG. 7 is a flowchart showing a process 700 for determining an object to user focus and to provide a visual element in association therewith. The process 700 may be implemented, in whole or in part, by the systems shown in FIGS. 1 and 6. One or more actions of the process 700 may be incorporated into or combined with one or more actions of any other process or embodiments described herein. The process 700 may be saved to a memory or storage (e.g., the storage of the system shown in FIG. 6) as one or more instructions or routines, which may be executed by any suitable device or system having access to the memory or storage to implement the process 700. At 702, a user of the media player device 101 may receive a user input indicating a user invitation limitation, which may designate an area. Devices, such as handheld devices, located within the designated area may be invited to submit recommendations of media items to be added to a playlist that is being created by a user associated with the media player device 101.

At 704, the media player device 101 may also enable receiving user input that designates a content criterion, such as a genre of media items that may be acceptable for the playlist. At 706, the media player device 101 may transmit the invitations for submitting the media items. At 708, the media player device 101 may receive responses from one or more area devices, such as responses to a secure handshake, and the devices may submit recommendations or requests for media items to be added to the playlist.

At 710, the media player device 101 may determine whether the device submitting the recommendation is an invited device. If so, processing continues to 712, where the media player device 101 may determine whether the content item being recommended meets the content criterion that had been specified by the user input at 704. If not, then the media player device 101 continues to monitor for responses from devices.

At 714, the media player device 101 may make a determination as to where the content item recommended is available. For example, a first content item recommended for the playlist may be available locally on a memory accessible by the media player device 101. The media player device 101 may determine that a second content item is available on a hard drive of one of the invited devices, and may request it therefrom. The media player device 101 may determine that a third content item recommend for the playlist is available on a network server of a proprietary media content service, and then determine that one of the invited devices has a subscription to this proprietary media content service and may obtain a token comprising credentials for accessing this proprietary media content service. For example, such a token may be used only a single time with the media player device 101 acting as a proxy for the device that sent it the token and may access the media item only while the device that sent it the token is not accessing media items from the media content services.

In an embodiment, the invited device that has access to a media content service and provides the token need not be the device that requested the media item that is obtained from the media content service, but may be another one of the invited devices. Or, the token may be provided by any device within the area 107. Further, the media player device 101 may determine that a fourth media item is available from a second media content service to which another device of the invited devices has a subscription, and then the media player device 101 may obtain a token therefrom for accessing the second media content service. At 716, the media player device 101 may then play the media items of the playlist accordingly.

As shown at 718, the system may then determine whether the device that recommended the media item for the playlist is still present in the designated area. A presence of the invited devices in the designated area may be continually monitored and reported to the media player device 101.

If a device that recommended a media item is no longer present in the designated area, then at 720 media items recommended by that device may be removed, suspended or otherwise deprioritized, permanently or temporarily. If the device is still in the area, then the playing of the media items on the playlist may continue. The process may conclude after all the media items on the playlist have been played or the media items of the playlist may be looped until a user input received by the media player device 101 stops play.

It should be understood that the above steps of the flowchart of FIG. 7, like communication and processing diagrams of other figures that are part of the present disclosure, may be executed or performed in any order or sequence not limited to the order and sequence shown and described in the figures. Also, some of the above steps of the flowchart of FIG. 7 and of other figures provided as part of the present disclosure, may be executed or performed substantially simultaneously, where appropriate.

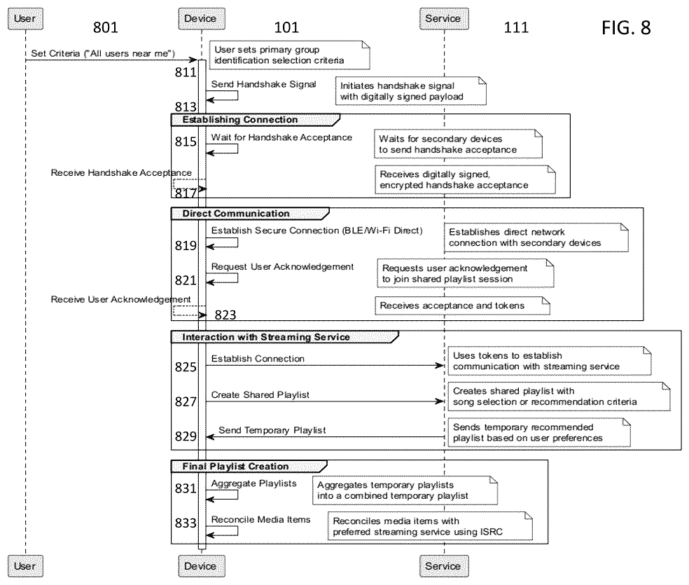

FIG. 8 illustrates a communication and processing flow diagram according to an aspect of the disclosure. As shown at 811, user 801 may set in media play device 101 an invitee criterion, such as all users near me. At 813, the media player device 101 may transmit A handshake signal to one or more devices 103a-e. At 815, media player device 101 may wait for a handshake acceptance transmission from one or more devices 103a-e, and at 817 the media player device 101 may receive the accepted handshake. At 819, a secure connection may be established between devices in an area 107, including the media play device 101 and one or more additional invitee devices that have accepted the handshake. At 821, the media play device 101 may request acknowledgement from devices 103a-e of their request to contribute to the creation of the play list, and at 823 the media play device 101 may receive the acknowledgements.

In an embodiment, a user of the media play device 101 may have the option to select all proposed or recommended media items or pick individual media items from their preferred media item streaming service. Also, the user may be enabled to deselect media items the user does not want to be included on the playlist. This may enable the user to curate the shared playlist, offering a personalized touch. In another embodiment, a totally hands-off interactions is enabled if the user has un-selected a shared playlist global setting such as “let me decide which songs to share”.

At 825, the media play device 101 may establish a connection to one or more media content provider platforms 111. The media play device 101 may transmit one or more tokens for downloading or streaming one or more content items. At 827, the media play device 101 may create the content indicated by the shared playlist, or a portion thereof, and at 829 this content may be accessed by the media play device 101.

At 831, one or more portions of the content indicated by the playlist accessed from different media content provider platforms 111 may be aggregated. At 833, the media play device 101 may reconcile media content with the media content provider platforms 111 from which they are available. In this way, a more complete content set based on the playlist may be obtained.

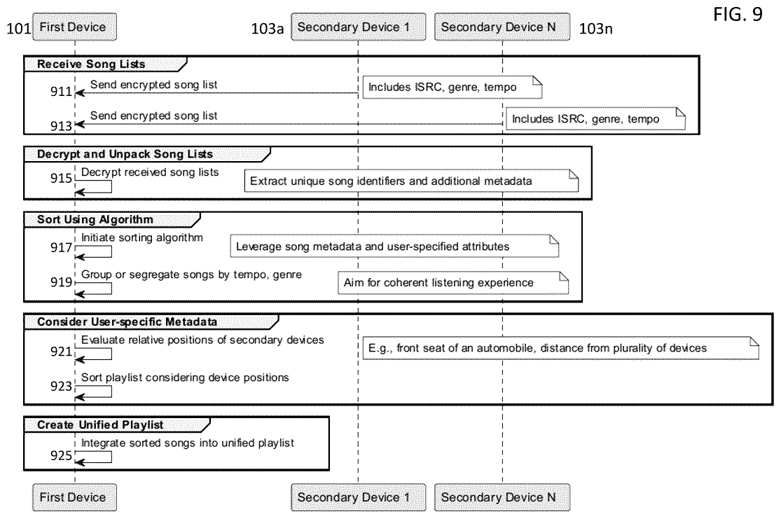

FIG. 9 is a communication and processing flow diagram showing prioritization of some content items indicated on the playlist over other content on the playlist, according to an embodiment. At 911, 913, the media play device 101 may receive one or more content item recommendations from each of devices 103a, 103b, 103c . . . 103n. The media item recommendation may include metadata, such as a version or particular recording of a content item, such as a cover by an artist or a remake of a film, a particular musical arrangement or tempo for the content item and the like.

At 915, the media play device 101 may decrypt the content item media item recommendation received and the additional metadata. For example, each device 103a, 103b, 103n may transmit only a music catalog designation to refer to a song, and possibly metadata therewith. The transmission to the media play device 101 may also be encrypted with the digital signature of the respective device 103.

At 919, the media play device 101 may sort the playlist and group media item recommendations. The first media playback device 101 may utilize a sorting algorithm that may make use of media content metadata and/or additional attributes that may be determined by the at media playback device 101. For example, the position of the recommending device relative to the media playback device 101 and to the plurality of other recommending devices may be considered: if a first recommending device is determined to be closer to the media playback device 101, or if the first recommending device is in the front seat of an automobile while other recommending devices are in the rear seat, then content items added to the play list by the first recommending device may be prioritized or deprioritized on the play list compared with content items recommended by other devices that added content item recommendations to the playlist.

At 921, the media play device 101 may prioritize content items so that prioritized content items may be played earlier, or may be played more frequently than non-prioritized content items. Other considerations in determining content item priority may be the order of devices accepting and joining the shared playlist, the order of devices making their first content item recommendation, and/or the order in which content items were added to the playlist. For example, a song recommended by a device 103b that was invited first, or that first accepted the invitation, or that made its first recommendation for the playlist, may be positioned ahead of other songs on the playlist. In another example, the playlist aggregation by the media play device 101 includes detecting common songs within the plurality of content items recommended by devices 103a-e and placing them ahead of songs on the playlist that were recommended by only one device or that were recommend by fewer than the number of devices that recommended the most recommended song. Thus, a media item added to the playlist by three of the devices 103a-e may be given higher priority than a content item added to the playlist by two devices. By way of further example, a first content item that comes closer to the content criterion set for the playlist may be prioritized over other content items on the playlist. For example, if the content criterion is old jazz, then a Louis Armstrong recording may be prioritized over Miles Davis. Metadata about the content item may be used by the media play device 101 to determine whether the content item comes closer to the content criterion. A trained machine learning model may be used to determine what content items more truly or purely meet the requirement of the content criterion.

At 923, the media play device 101 may order or re-order the playlist according to the priorities assigned to content items. At 925, the media play device 101 may integrate the media items into a unified, sorted and prioritized playlist.

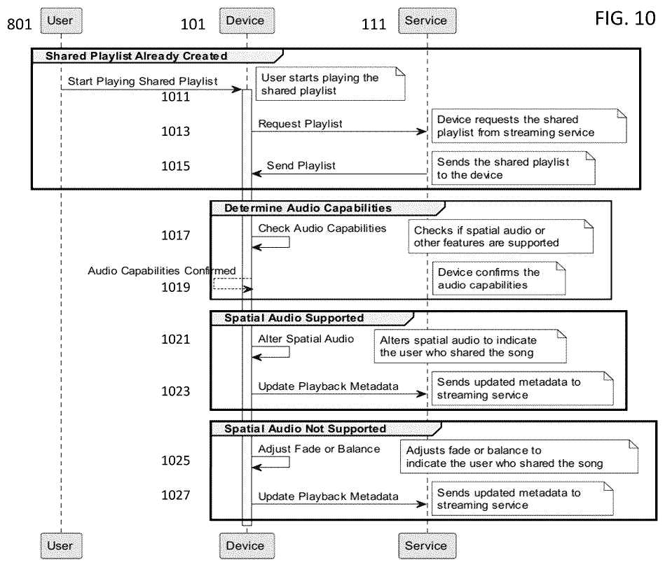

FIG. 10 shows an embodiment in which the media playback device 101 or the media item streaming service 111 may alter or adjust the play media item such that it is indicative of the user from whose device the song was contributed to the play list. At 1011, the media playback device 101 may start playing the media items indicated on the playlist. This may be initiated at 1013, when the media playback device 101 requests the first media item from a media item streaming service 111. At 1015, the media item streaming service 111 transmits the media item to the media playback device 101.

At 1017, the media playback device 101 may check its audio output capabilities. At 1019, the media playback device 101 may determine that it has spatial audio capabilities. For example, if spatial audio is available, then at 1021 the media playback device 101 may alter (or may inform the first media item streaming service or a secondary media item streaming service to alter) the spatial audio in such a way to create the effect that the audio emanates or begins from the area or location of the device associated with the adding of the requested media item to the playlist, or the location of the user or user profile who added the song to the playlist. Spatial audio or 3D audio effects may include one or more sound effects of a group of sound effects that manipulate the sound produced by stereo speakers, surround-sound speakers, speaker-arrays, or headphones. This may entail the virtual placement of sound sources anywhere in three-dimensional space, including behind, above or below the listener. 3-D audio processing is the spatial domain convolution of sound waves using head-related transfer functions. Sound waves may be transformed, for example, using head-related transfer function or HRTF filters and cross talk cancellation techniques, to mimic natural sounds waves, which emanate from a point in a 3-D space. It allows trickery of the brain using the ears and auditory nerves, pretending to place different sounds in different 3-D locations upon hearing the sounds, even though the sounds may just be produced from just 2 speakers, or may entail using surround sound. This may be done by the media playback device 101 at 1023 updating playback metadata of the media item to the media item streaming service 111. Other implementations may adjust or alter the fade or balance the media item, as shown at 1025, and update the metadata of the content item accordingly for the media item streaming service 111. This may be done, for example, when more sophisticated spatial audio is not available or when the media playback device 101 (such as a car audio system) does not support spatial audio.

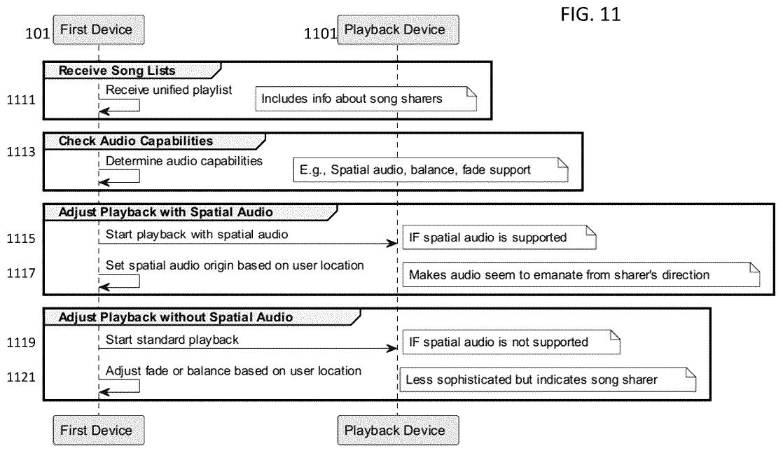

FIG. 11 shows and implementation which the media playback device 101 makes use of a second playback device 1101, which may have more sophisticated audio capabilities. At 1111, the media playback device 101 may receive or may generate the playlist. At 1113, the media playback device 101 may determinate its own audio capabilities, such as spatial audio, balance between speakers come off fade support and the like. Additional considerations may be the ability to generate sound to a speaker that has separate woofer, subwoofer, tweeter and midrange. At 1115, the media playback device 101 may play the adjusted content item. At 1117, the media playback device 101 may set the spatial audio effects according to the recommending device's location, or according to a current location of the user associated with the device where the media item was recommended to the playlist.

If the media playback device 101 determines that a second playback device 1101 has spatial audio or has other sound location effects, or overall better sound quality, then the media playback device 101 may transmit the content item to be played by the second playback device 1101, instead of playing the content item by the media playback device 101. The second playback device 1101 may be one or more of the devices 103a-f. Instead, or in addition, at 1119, the media playback device 101 may play the content item or may request the second device 1101 to play the content item using more standard playback features, such as by adjusting balance, fade, equalizer functions, and/or the like.

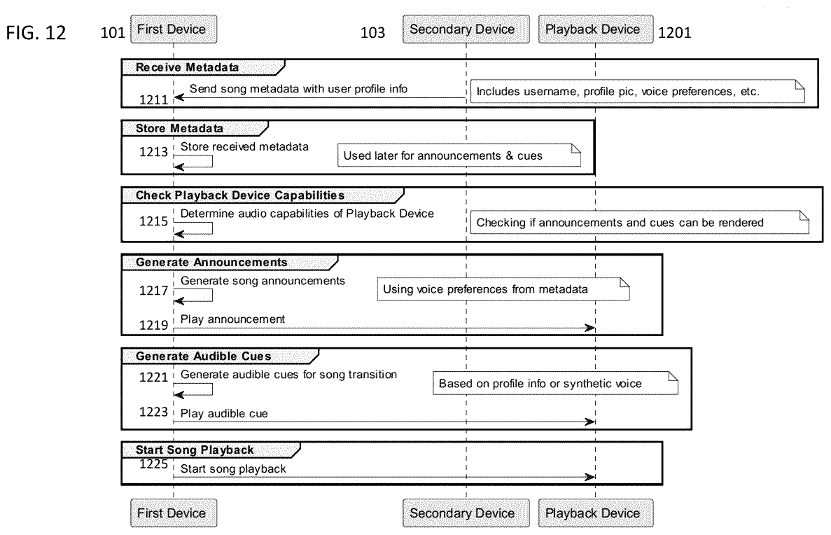

In an embodiment illustrated in FIG. 12, the metadata received from secondary devices may include user profile information, such as, but not limited to username, profile photo, image or other picture, device name, preferred “voice”, recordings of the user's voice, or pre-generated audio synthesized by the user's device that mimics the user's actual voice. This metadata may be used by the system to generate song announcements, create audible cues in between or when transitioning between songs so that the content item played is noticeably associated with the user of the device where the content item was added to the playlist.

At 1211, the media playback device 101 may receive metadata for the media item that may tend to associate the media item played with the user who added the content item to the playlist. At 1213, the media playback device 101 may store this metadata.

At 1215, the media playback device 101 may determine its audio capabilities and/or the audio capabilities of the sound system to which it may output the content item. For example, the media playback device 101 may determine that via Wi-Fi it has access to a home sound system with quality speakers or to an automobile surround sound system, in which case it would output the content via that.

At 1217, the media playback device 101 may generate media item announcements that tend to associate the content item being played (or about to be played, or recently played) with the user to add the content item to the playlist. For example, at 1219, the media playback device 101 may transmit to the second playback device 1201 an announcement by that user. In addition, or instead, at 1221, the media playback device 101 may generate audible cues for a transition between media items that tend to associate the content item being played (or about to be played, or recently played) with the user to add the content item to the playlist.

At 1219, the media playback device 101 may transmit to the second playback device 1201 such audible cues. At 1225, the media playback device 101 may transmit to the second playback device 1201 the content item to be played. In another example, the user profile may indicate that preferred audio cues may be based off the artist of the song being played. In such an example, the system may synthetize an audio cue, such as an announcement indicating which song (title, artist) and which user's personal playlist the song is being extracted from prior or which user recommended it for the playlist. Then while playing the song or while transitioning from a previous song to this song, the artist's voice may announce the user who originated the song for the playlist. A trained machine learning model trained on the voice of the artist of the song may be used to generate such an announcement.

In an embodiment, devices 103a-e that contributed recommendations for media items to be added to the playlist may be enabled to modify the playlist. In an embodiment, devices 103a-e may be enabled to add further media item recommendations for the playlist at this time, for example, as users see others' recommendations and are reminded of additional media items. As discussed above, a media app associated with a media content provider 111a and running on device 103x may enter the media items suggested by one or more other devices 103a-e to media content provider 111a, which would generate a new ephemeral recommendation for the playlist to be transmitted to the media play device 101.

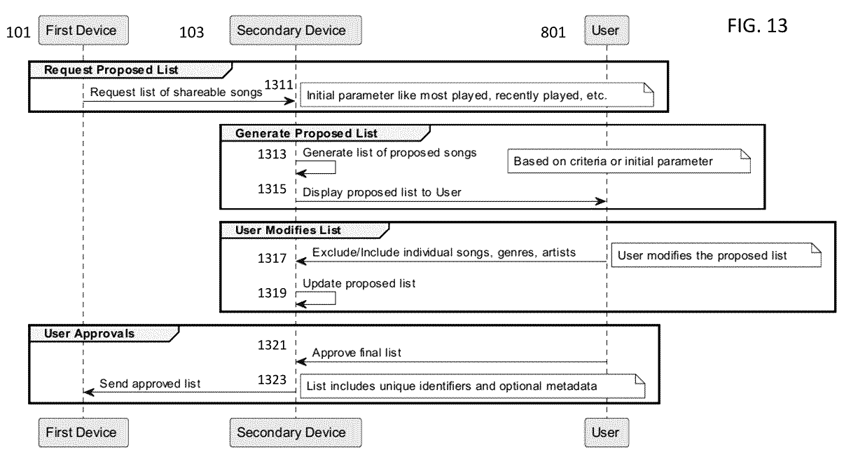

As shown in FIG. 13, at 1311 the media playback device 101 may transmit to the devices 103a-e an invitation to contribute to the playlist. The invitation may specify a genre or one or more other media item criteria for media items that may be added to the playlist. At 1313, the invited devices 103a-e may propose media items for the playlist.

A draft of the playlist may be transmitted to all the devices that contributed recommended media items to the playlist. According to an aspect of this embodiment, all devices that were invited to contribute to the playlist, even devices that did not actually contribute to the playlist are enabled to modify the playlist. In an embodiment, the media playback device 101 may transmit the playlist only to those devices 103 that request the playlist. At 1315, the proposed playlist may be presented to users of the devices 103-a-e for approval or disapproval by users of the devices 103a-e.

As shown at 1317, in an embodiment, a user may be shown media items that were suggested by other users and may propose to exclude individual media items, or to change genres, artists and/or other playlist criteria. In an embodiment, such proposals for excluding media items or for changing playlist criteria would take effect only if the media playback device 101 receives user input ratifying the exclusion or the change. Alternatively, any contributing device 103a-e may exclude any media item or change playlist criteria. At 1319, the playlist may be changed accordingly. In an embodiment, such a change to the playlist may be entered to the media content provider 111a, which would then generate one or more new ephemeral recommendation(s) for the playlist according to the change.

At 1321, users of the devices 103a-e may be shown the revised playlist after the playlist modification. In an embodiment, the devices 103a-e may make further decisions to exclude media items or to change playlist criteria, or may make further requests to exclude media items or to change playlist criteria, so that the playlist may be an iterative process of changes and revisions. At 1321, users of the devices 103a-e may be enabled to finally approve the playlist. At 1323, the final approved playlist may be transmitted to the media playback device 101. In an embodiment, the media playback device 101 may make further revisions to the playlist after 1323.

In an embodiment, the system may detect when a new device enters the proximal area 107 after the group has already initiated the playlist-sharing process and may add the new device as an invitee device 103. According to an embodiment, the system may continue to monitor for new devices entering area 107 and/or meeting invitee criteria, for example, joining online, being added as a member to a WhatsApp chat, or the like.

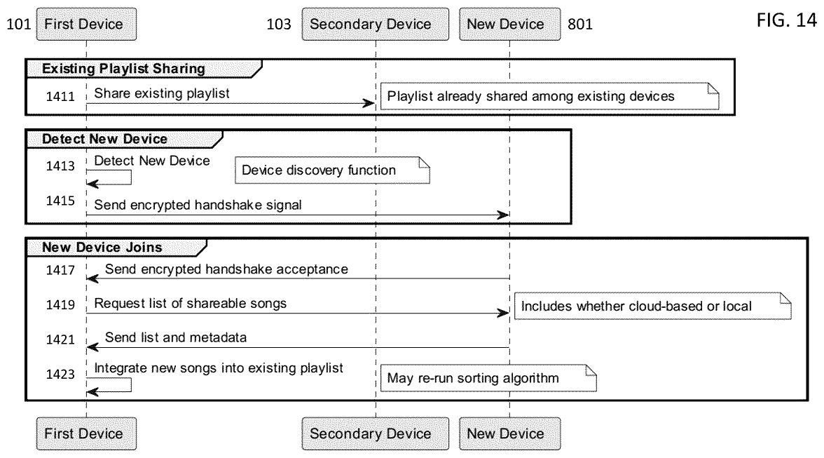

As shown in FIG. 14, after 1411, the media playback device 101 may share the existing playlist with known devices that contributed media item recommendations to the playlist, or with all invited devices. At 1413, the media playback device 101, upon detection of the new device 103 within the predetermined area 107, may initiate transmission of an encrypted handshake signal can be sent to the new device, inviting it to join the existing shared playlist session at 1415. At 1417, the new device 103 may transmit acceptance of the handshake with the media playback device 101, and at 1419 the media playback device 101 may invite the new device 103 to recommend media items for the playlist. At 1421, the new device may transmit to the media playback device 101 recommendations to be added to the playlist together with metadata for the recommended media items. The metadata may indicate whether the media item is available to the new device in storage locally, available via a streaming or other online service or platform free of additional charge or for a fee, and/or may include a token with credentials for accessing the media item recommended. At 1423, the media playback device 101 may add the media item to the playlist. Upon receiving the new device's recommendations and metadata, the media playback device 101 may re-run the sorting algorithm to reorganize the entire playlist, considering the new additions or intersperse the new songs among the existing songs based on the existing sorting criteria.

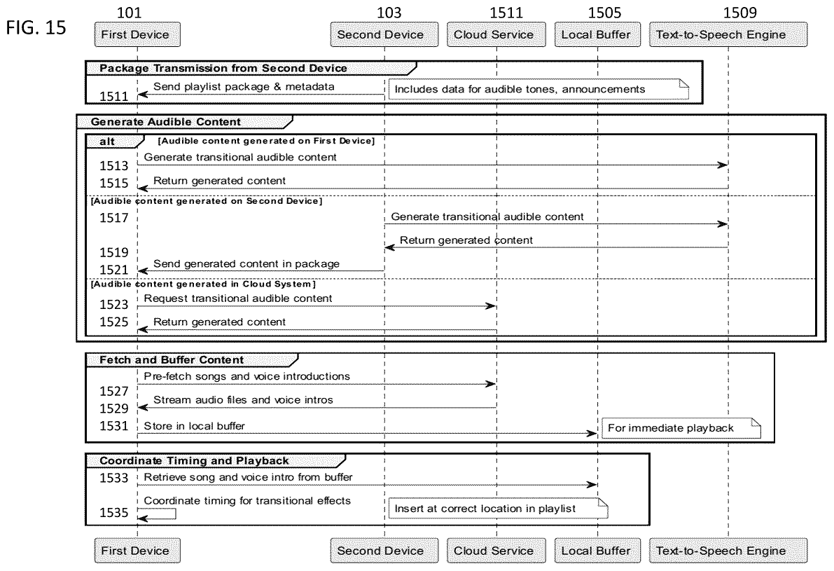

In an embodiment shown in FIG. 15, the metadata transmitted by devices 103a-e together with the recommendations indicating media items includes metadata that may be used to generate audible tones, sounds, announcements, or introductions to songs. For example, the system could utilize a text-to-speech engine 1509 to generate introductions to songs that may indicate or give a clue to which user shared the media item to the playlist.

As shown at 1511, devices 103a-e transmit to the media playback device 101 media item recommendations together with metadata that may be used to generate audible tones, sounds, announcements, or introductions to songs. The media playback device 101 may generate the audible content based on such metadata. At 1513, the media playback device 101 may transmit such metadata to the text-to-speech engine 1509, which, at 1515 may return to the media playback device 101 the audible content generated based on such metadata. In an embodiment, the audible content may be a user's voice that is synthesized and may be generated by the device 103 that transmitted the metadata and the media item recommendation for the playlist. As shown at 1517, the device 103 may transmit the metadata to the text-to-speech engine 1509, which, at 1519 may return the generated audible content to the device 103. Then, at 1521, the generated audible content may be transmitted to the media playback device 101.

In an embodiment, the audible content may be generated in a cloud system 1511 such as a text-to-speech cloud service. At 1523, the audible content may be requested from the cloud system 1511, which, at 1525 may return the generated audible content to the media playback device 101. Also, these voice introductions or other audible content, when generated by a cloud system, may be pre-fetched and buffered on the first device. As shown at 1527, the media playback device 101 may request the voice introductions or other audible content from the cloud service 1511, which, at 1529 may return the generated audible content to the device 103. The media playback device 101 may store the audible content in a buffer 1505. Accordingly, at 1533, the media playback device 101 may coordinate the retrieving and playing of the media item on the playlist with the retrieval of the audible content associated with the media item and, at 1535, coordinate the play of the audible content just before, during or after the playing of the media item. In an embodiment, both the pre-fetched media item and the voice introduction or other audible content may be managed within the same local buffer. The media playback device 101 may coordinate the timing for these elements, ensuring that the voice introductions or other transitional effects are appropriately inserted at the correct location within the playlist, for example, between songs without or without overlapping or in some cases during the song playback as appropriate.

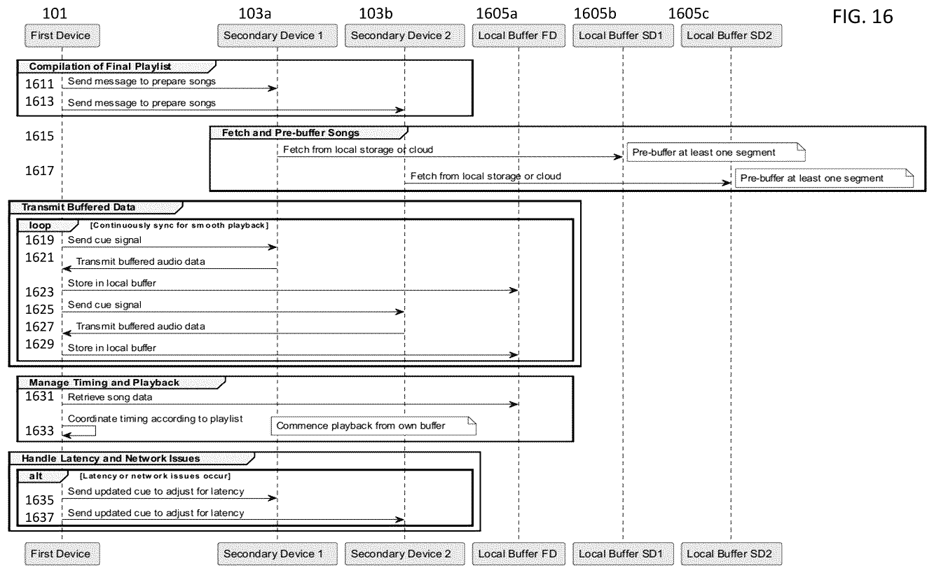

FIG. 16 illustrates an example of communication and processing flow in an embodiment without a centralized cloud media content library or service. Media items may be distributed across multiple users' devices and personal cloud libraries, but a peer-to-peer system may be implemented to stream the media item from each device 103a-e to the media play device 101. According to an embodiment, the media play device 101 may request each device 103a-e to play, buffer, and transmit their selected songs.

After the media play device 101 has compiled the final playlist, at 1611, 1613 the media play device 101 may send a message to each device 103a, 103b, requesting it to prepare its respective media items for playback. Each device 103a, 103b may fetch its designated media items, either from local storage or its own cloud library, and pre-buffer at least one segment of the audio data. At 1615, 1617, in response to a signal from the media playback device 101, the devices 103a, 103b may fetch their buffered audio data from local buffers 1605b, 1605c. At 1619, the media play device 101 may request the content and, 1621, the content may be transmitted to the media playback device 101. The media playback device 101 may store the content in a local buffer 1605a. This process of retrieving content data by the media play device 101 from the device 103 and storing the content by the media playback device 101 may be looped, as shown at 1625-1629. By continuously syncing with the devices 103a, b, the media playback device 101 may ensure that it always has sufficient buffered data for smooth playback. The media playback device may also manage the timing and sequence of the media items for playback according to the final playlist and commences playback from its own buffer. Thus, at playback time, at 1631 the media playback device 101 may retrieve the content from the buffer 1605a, and at 1633, the media playback device 101 may coordinate the timing of the play of content. Latency may be managed by the media playback device 101. At 1635, the media playback device 101 may send requests for update to the devices 103a, 103b, as needed.

Playback of the media items of the playlist may be according to the order in which they were received. In an embodiment, media items may be ranked-promoted or demoted on the playlist—based on user input to the media playback device 101 or based on various factors. In an embodiment, the system may integrate a time-decay function that adjusts the playlist order or updates the sorting of the playlist based on the changing proximity of device 103 to the media playback device 101. For example, if the device 103a that recommended the media item for the playlist is, at the time of playback of the media items of the playlist, in closer physical proximity to the media playback device 101 than are other devices 103, or if the device 103a that recommended the media item was closer to the media playback device 101 than were other devices 103 at the time that the device 103a recommended the content item, than the content item recommended by 103a may be pushed to the head of the playlist for playback.

The order of media items of the playlist at playback may be sorted according to a relationship of users associated with the devices 103 to the media playback device 101. For example, if the device 103 in the past has made a number media item recommendations for a playlist of the media playback device 101, or if the device 103 in the past has made a number media item recommendations that a user of the media playback device 101 accepted (did not exclude) from the playlist, then media items from the device 103 may be promoted to the head of the playlist for playback.

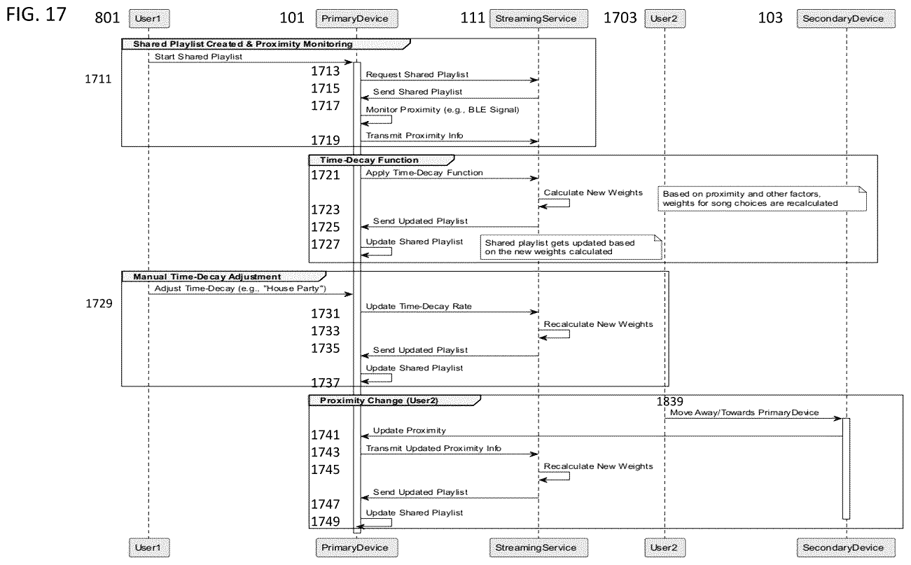

As shown in FIG. 17, after the user 801 at 1711 initiates the media playback device 101 to start playback, at 1713, the media playback device 101 may establish a secure connection with the media content provider platform 111, or with more than one such media content platform 111a, 111b, 111c . . . 111n. In response, at 1715, the media content provider 111 transmits the media items to the media playback device 101.

At 1717, the media playback device 101 may detect physical proximity of devices 103a-e that had requested media items. At 1719, the media playback device 101 may transmit the proximity information, or a ranked list indicating the physical proximity of the devices 103a-e, to the media playback device 111, which may then transmit the media items in the specified order accordingly.

As shown at 1721, the media playback device 101 may continuously monitor the proximity of each connected device 103a-e. This may be accomplished using Bluetooth Low Energy (BLE) signal strength measurements or other proximity-determining technologies as is known in the art. This proximity information may be transmitted by the media playback device 101 to the media content provider 111. At 1723, new weights for the media items are calculated and, at 1725, an updated list is transmitted to the media playback device 101. At 1727, the media playback device 101 updates the playlist based on the received order. Or, the media playback device 101 may reshuffle the order according to the new order and then request the media items from the media item service 111 according to the adjusted playback order.

As a device 10a-e moves further away from the media playback device 101, the time-decay function may start to decrease a weight of that device's media item recommendations that had been added to the playlist. Conversely, as a device 103a-e moves closer to the media playback device 101, the time-decay function may increase the weight of that device's media item contributions. This ensures that those who are closer to the media playback device 101 have a greater influence on the shared playlist. For example, if a user of a device 103a who has added a media item to the playlist then moves away from the event or gathering (for example, outside of area 107), that user's media items will gradually lose its position in the playlist, allowing media items selected by users who are closer to take precedence. Also, in an embodiment, media items that are available locally without the need to use subscription information to access a media content streaming service 111 may be given priority at playback time.

At 1729, the user 801 of the media playback device 101 may adjust the order of the playlist. At 1731, the media playback device 101 may transmit an update to the media content provider 111, in response to which at 1733, the media content provider 111 updates the playlist and at 1735 shares the updated list with the media playback device 101. At 1737, the media playback device 101 may update the playlist accordingly.

As shown at 1739, an adjustment in the playlist order may also be triggered by a movement of a device 103 or user 1703 thereof. In response to such movement, at 1741 the proximity of the device 103 may be updated to the media playback device 101. At 1743, the media playback device 101 may update the media content provider 111 with the proximity information, in response to which at 1745, the media content provider 111 updates the playlist and, at 1747, transmits the updated playlist to the media playback device 101, which may update the playlist at 1749.

The rate of time decay may be adjusted in real-time based on various factors such as event type, the number of connected devices, or user preferences. In certain scenarios, the media playback device 101 may also manually adjust the rate of time decay through a graphical user interface mechanism such as selecting “House Party”, “Party Bus” or “Car Share”. Depending on the selection, the rate of time decay may vary to reflect the sharing conditions. Illustratively, in a “car share” situation, the time decay may be set to zero to reflect that users cannot really move away.

By way of further example, in a “party bus” situation, time decay may be set to a high value to reflect that a contributor to a shared playlist may move away from the originator of the shared playlist (the host) but to a very limited distance thus accentuating the effect, whereas in a “house party” situation, the time decay may be average to ensure that a media item contributor would have to move significantly away from the media playback device 101 for the shared playlist to be re-sorted.

The processes described herein as being performed by the media content provider, the second media content provider, servers of the media content provider or the second media content provider, the media playback device, the secondary devices in the area or outside the area, and their systems, may be performed by an application and/or any instructions for performing any of the embodiments described herein may be encoded on computer readable media. While in some embodiments, a media content service may be thought of as an internet platform, and sometimes described as a server, a group or bank or rack or farm of servers together with ancillary equipment may also be intended. Computer readable media may include any media capable of storing data. The computer readable media may be transitory, including, but not limited to, propagating electrical or electromagnetic signals, or may be non-transitory including, but not limited to, volatile and non-volatile computer memory or storage device, solid state device, hard drive, optical drive, a hard disk, floppy disk, USB drive, DVD, CD, media cards, register memory, processor caches, Random Access Memory (“RAM”), etc. Hardware implementations of these processes and implementations combining hardware and software are also contemplated.

As referred to herein, the phrase “the media playback device,” “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. On these user equipment devices, users may be able to navigate among and locate the same content available through a television. Consequently, media item consumption, media item recommendations and guidance, interaction with content providers and the like, may be available on these devices, as well. The content, media item recommendations, and media item interactions may be for content available only through speakers of a device, for content only available via a television, for content available only through a computer monitor or through one or more of other types of user equipment devices, or for content available both through a television and computer monitor or other types of user equipment.

As referred to herein, the phrase, “content item recommendation” or “media content recommendation” should be understood to mean any display or discernable signal related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, popup ads, etc.), on-demand information, blogs, websites, and any other type of guidance data that is helpful for a user to navigate among and locate desired content selections.

A content provider may provide programming according to a schedule, such as television or cable programming, and non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider Internet content may include web events, such as a chat session or Webcast, or content available on-demand as streaming content or downloadable content through an Internet web site or other Internet access (e.g. FTP).

The term “and/or,” may be understood to mean “either or both” of the elements thus indicated. Additional elements may optionally be present unless excluded by the context. Terms such as “first,” “second,” “third” in the claims referring to a structure, module or step should not necessarily be construed to mean precedence or temporal order but are generally intended to distinguish between claim elements.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

It should also be noted that the systems and/or methods described above may be applied to, or used in accordance with, other systems and/or methods. In various embodiments, additional elements may be included, some elements may be removed, and/or elements may be arranged differently from what is shown. Alterations, modifications and variations can be effected to the particular embodiments by those of skill in the art without departing from the scope of the present application, which is defined solely by the claims appended hereto.

1. A method comprising:
receiving, at a first device, a user input indicating an invitee limitation for participation in generating a media content list;
receiving, at the first device, a content criterion input indicating a content requirement for the media content list;
transmitting to a second device, based on the invitee limitation, an invitation for generating the media content list, wherein the second device is distinct from the first device;
receiving by the first device, from the second device, at least one media item recommendation;
retrieving media content description information for the at least one media item recommendation;
determining automatically, based on the media content description information, that the at least one media item satisfies the content requirement indicated by the content criterion input for the media content list; and
adding the media item received to the media content list.

2. The method of claim 1, wherein the invitation for generating the media content list is transmitted by the first device via a communication network.

3. The method of claim 1, wherein the invitee limitation excludes devices outside of a range of radio communication or outside of a Wi-Fi range.

4. The method of claim 1, further comprising:
receiving, by the first device, a token comprising a credential for accessing the media content service, wherein the first device requests the media item from the media content service using the credential.

5. The method of claim 1, further comprising:
in response to detecting that the second device is not present within a range of radio communication or within a Wi-Fi range, removing the media item from the media content list.

6. The method of claim 1, further comprising:
in response to detecting that the second device is not present within a range of radio communication or within a Wi-Fi range, deprioritizing the media item on the media content list.

7. The method of claim 1, wherein the media item is a first media item, and further comprising:
adding to the media content list a second media item recommended by a third device; and
in response to detecting that the second device is more remote from the first device than is the third device, moving the first media item below the second media item on the media content list, wherein remoteness is detected based on signaling within a radio communication area or within a Wi-Fi range.

8. The method of claim 1, wherein the content requirement indicated by the content criterion input is a requirement for a content genre for the media content list.

9. The method of claim 1, further comprising:
receiving, by the first device from the second device, a content criterion modification request;
setting, by the first device, a modified content criterion by modifying the content requirement indicated by the content criterion input according to the content criterion modification request; and
updating the media content list according to the modified content criterion.

10. The method of claim 1, further comprising:
playing, by the first device, the media item based on the media content list, wherein the media item is played using a sound effect indicating a direction or distance of the second device from the first device.

11. The method of claim 1, wherein the media item is a first media item, and the media content service is a first a media content service, and further comprising:
receiving a second media item recommendation transmitted by a third device; and
in response to determining, by the first device, that the second media item is available from a second media content service, requesting, by the first device, the second media item from the second media content service, wherein the second media content service is distinct from the first media content service.

12. A system comprising:
a memory; and
control circuitry configured:
to receive, at a first device, a user input indicating an invitee limitation for participation in generating a media content list and to store in the memory the invitee limitation;
to receive, at the first device, a content criterion input indicating a content requirement for the media content list;
to transmit to a second device, based on the invitee limitation, an invitation for generating the media content list, wherein the second device is distinct from the first device;
to receive by the first device, from the second device, at least one media item recommendation;
to retrieve media content description information for the at least one media item recommendation;
to determine automatically, based on the media content description information, that the at least one media item satisfies the content requirement indicated by the content criterion input for the media content list; and
to add the media item received to the media content list.

13. The system of claim 12, wherein the invitation for generating the media content list is transmitted by the first device via a communication network.

14. The system of claim 12, wherein the invitee limitation excludes devices outside of a range of radio communication or outside of a Wi-Fi range.

15. The system of claim 12, wherein the system is configured:
to receive, by the first device, a token comprising a credential for accessing the media content service, wherein the first device requests the media item from the media content service using the credential.

16. The system of claim 12, wherein the system is configured:
in response to detecting that the second device is not present within a range of radio communication or within a Wi-Fi range, to remove the media item from the media content list.

17. The system of claim 12, wherein the system is configured:
in response to detecting that the second device is not present within a range of radio communication or within a Wi-Fi range, to deprioritize the media item on the media content list.

18. The system of claim 12, wherein the media item is a first media item, and wherein the system is configured:
to add to the media content list a second media item recommended by a third device; and
in response to detecting that the second device is more remote from the first device than is the third device, to move the first media item below the second media item on the media content list, wherein remoteness is detected based on signaling within a radio communication area or within a Wi-Fi range.

19. The system of claim 12, wherein the content requirement indicated by the content criterion input is a requirement for a content genre for the media content list.

20. The system of claim 12, wherein the system is configured:
to receive, by the first device from the second device, a content criterion modification request;
to set, by the first device, a modified content criterion by modifying the content requirement indicated by the content criterion input according to the content criterion modification request; and
to update the media content list according to the modified content criterion.

21-55. (canceled)
